(19) United States
(12) Patent Application Publication
(10) Pub. No.: US 2010/0213212 A1
(43) Pub. Date: Aug. 26, 2010

(54) ILLUMINATED BOTTLE CLOSURE AND ILLUMINATED DISPENSER AND METHOD FOR ILLUMINATING A DISPENSER

(75) Inventors: Udo Custodis, Happy Valley (HK); David Dussault, Neutraubling (DE); Helmut Neuhauser, Geisenfeld (DE); Frank Schirrmacher, Wan Chai (HK); Dirk Wittenberg, Muenchen (DE)

Correspondence Address: Viering, Jentschura & Partner - OSR, 3770 Highland Ave., Suite 203, Manhattan Beach, CA, 90266, US

(73) Assignee: OSRAM Gesellschaft mit beschraenkter Haftung, Muenchen (DE)

(21) Appl. No.: 12/664,689

(22) PCT Filed: Jun. 25, 2008
(86) PCT No.: PCT/EP08/58071

§ 371 Date: Dec. 15, 2009

(30) Foreign Application Priority Data
Jul. 11, 2007 (DE) 10 2007 032 297.8

(51) Int. Cl. B65D 51/24; F21V 33/00

(52) U.S. Cl. 222/113; 220/212

(57) ABSTRACT

An illuminated bottle closure with a dispenser function for a hollow body is provided. The illuminated bottle closure may include at least one light source, wherein the at least one light source is configured to be switched on for a predetermined time when the dispenser is actuated and illuminates at least one of the liquid dispensed and the liquid contained in the dispenser.

### TECHNICAL FIELD

The invention relates to illuminated dispensers of household liquids such as perfumes, body lotions or liquid soaps, for example. The dispenser in this case preferably illuminates the liquid dispensed by said dispenser. The invention preferably relates to spray dispensers, i.e. dispensers which spray their contents in response to the depression of a button, as is conventional, for example, in a perfume bottle. In this case, the spray dispensed is preferably illuminated, which results in a light effect which is very appealing to people.

### PRIOR ART

U.S. Pat. No. 5,683,168 A has disclosed a torch with an integrated spray dispenser. The torch and the spray dispenser have to be operated separately, however, with it not being possible for either the spray or the content of the dispenser to be illuminated. U.S. Pat. No. 5,868,840 A discloses a spray gun for varnishing surfaces with an integrated laser, which illuminates the surface to be varnished, and, by virtue of various light sensors and an optical processing unit, gives an indication of the quality of the varnished surface. DE 20 2004 013 766 U1 has disclosed a perfume bottle with LED lighting, in which the LEDs are provided on the inside or on the outside and are fed via a battery. None of the documents discloses illuminating, for example, the spray or the liquid which is poured or pressed out during use. An illuminated bottle closure is likewise not suggested by any of the documents.

### OBJECT

The object of the invention is therefore to specify an illuminated dispenser which illuminates the liquid during use and therefore produces an appealing light effect. This object is achieved by a dispenser having the features of claim 1.

A further object consists in specifying an illuminated bottle closure, by means of which the liquid located in the bottle can be irradiated or illuminated. This object is achieved by the features of patent claim 17.

It is likewise the object of the invention to specify a method for illuminating a dispenser which ensures that the illumination functions reliably during use of the dispenser. This object is achieved by a method having the features according to claim 19.

### DESCRIPTION OF THE INVENTION

The invention is predominantly envisaged for packaging for liquid skincare products such as perfumes, skin lotions or liquid soaps. However, the invention can also be used for packaging for cleaning products, such as washing-up liquids, liquid detergents or all types of liquid cleaning agents, for example. By virtue of the hue of the corresponding illumination, specific brand features such as the company colors can be emphasized. The invention includes an apparatus which generates an energy pulse when the dispenser top is pressed, with this energy pulse being sufficient to operate a light source in the top of the dispenser for a certain period of time and to luminate the liquid. In this case, the spray or the liquid emerging from the dispenser can be illuminated, as well as the liquid contained in the dispenser. The energy pulse is generated by an apparatus which converts the mechanical energy produced when the dispenser top is pressed into electrical energy. Alternatively, an energy store can also be provided in the dispenser.

A further embodiment of the invention is predominantly envisaged for the closure of conventional drinks bottles, for example lemonade bottles, mineral water bottles, beer bottles, wine bottles or the like. However, any other desired hollow bodies such as canisters or the like can also be illuminated. The closure is in this case fixed on the bottle using conventional methods in order to seal said bottle. The illumination of the bottle contents can be provided by means of pushbutton switches, toggle switches, rotary switches or the like. Preferably, in this case the bottle contents are illuminated, but it is also possible for writing engraved in the bottle to be illuminated. In a multicolored variant, the emitted color can also be set via the switching mechanism. However, it is also conceivable for the emitted color to be changed automatically. This can take place continuously or abruptly. The color can be changed periodically or randomly. Naturally, this color display is also applicable to the dispenser top.

### BRIEF DESCRIPTION OF THE DRAWING(S)

FIG. 1 shows a schematic design of a dispenser according to the invention.

FIG. 2 shows a schematic design of the first embodiment of a bottle closure according to the invention.

FIG. 3 shows a schematic design of the second embodiment of a bottle closure according to the invention.

FIG. 4 shows a schematic design of the third embodiment of a bottle closure according to the invention.

FIG. 5 shows a schematic design of the fourth embodiment of a bottle closure according to the invention.

FIGS. 6a, 6b show a schematic design of the fifth embodiment of a bottle closure according to the invention with a spout.

### PREFERRED EMBODIMENT OF THE INVENTION

### Embodiment of the Dispenser

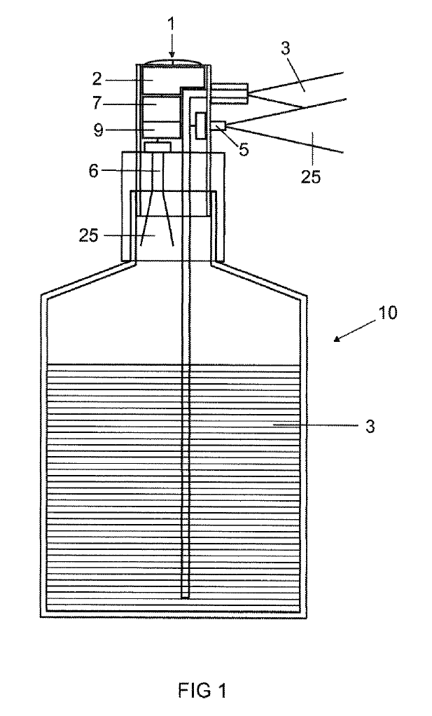

FIG. 1 shows the schematic design of a dispenser 10 according to the invention. The dispenser 10 preferably contains an energy generator 2, which generates electrical energy in the form of an energy pulse from the mechanical energy which is produced when the dispenser top 1 is pressed. The energy generator 2 can be a piezoelectric generator, an electrodynamic generator, a thermoelectric generator or else an electrostatic generator. A light source 5 is provided in the vicinity of the outlet opening of the liquid. In addition or as an alternative, a light source 6 can also be provided in the top of the dispenser 10 in such a way that it illuminates the liquid in the dispenser 10. However, a single light source can also be provided in the interior of the dispenser top and the light can be split into two focused light beams by virtue of prisms or other optical elements, with these light beams illuminating the spray and the content of the dispenser. The light source is preferably an LED or an OLED. The energy generator 2 is preferably dimensioned such that it can operate the light source directly. Alternatively, however, a driver circuit 9 can also be provided for operating the light sources. Said driver circuit in this case converts the energy produced by the energy generator 2 into a current suitable for the semiconductor light sources. In this case, an energy buffer store 7, such as a rechargeable battery or a double-layer capacitor (for example goldcap or ultracap), for example, can be provided. Preferably, the energy generator 2 is dimensioned such that sufficient energy is generated when the dispenser top is pressed once for the semiconductor light source(s) to be able to illuminate for approximately one second long. The semiconductor light source can in this case also be a color RGB LED or OLED. In a color embodiment, the color can be changed abruptly or continuously during the illumination. The change can take place periodically or randomly.

However, it is also conceivable not to provide the energy generator 2 and instead only to provide a battery or a rechargeable battery 7 for the provision of energy. This can be a cost-effective solution primarily for disposable dispensers which are not refilled once the contents have been used. The pushbutton 1 then only closes a switching contact or a timer switch when it is pressed. With this variant too, a driver circuit 9 can be provided which converts the voltage/current level of the rechargeable battery or of the battery to the level required for the semiconductor light sources and/or regulates the switch-on duration of the semiconductor light sources.

### Embodiment of the Bottle Closure

### First Embodiment

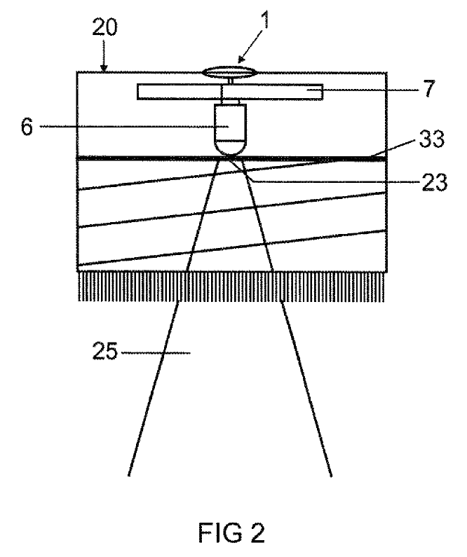

The bottle closure differs from the dispenser merely in that it can be positioned universally on various conventional bottles or other hollow bodies in order to seal and to illuminate said bottles or hollow bodies. Since an energy generator often does not make any sense for bottle closures because suitable mechanical work is not performed during use, a conventional battery is provided for the energy storage. In the first embodiment, the entire closure is encapsulated, and therefore the battery cannot be replaced. This closure is therefore envisaged only for a single-use closure for a bottle. FIG. 2 shows the design. The closure is in the form of a screw-type closure. In this case, the lower part comprises the actual screw-type closure, which has either a transparent material as the seal or which, as is shown in FIG. 2, has a seal made from an opaque material with a window 23 made from a transparent material, through which the light can pass. In the upper part there is an LED 6, which is supplied by a battery 7 and is switched on and off by means of a pushbutton switch 1. The battery 7 is in this case in the form of a button cell. The LED can illuminate the bottle contents with a focused beam 25, as is illustrated in FIG. 2, but it is also possible as an alternative or on its own for an LED to be provided which emits light upwards.

The bottle closure can be configured in such a way that the LED is either switched on and off or is only switched on for a predetermined period of time when the pushbutton switch 1 is pressed. Furthermore, the LED can be in the form of a colored RGB or RGGB-LED. The switch is then designed in such a way that the emitted color of the LED can be set also via said switch. However, other settings for setting the color are also conceivable, for example acoustic, body acoustic or additionally provided mechanical apparatuses.

It is also conceivable for the pushbutton switch not to be positioned at the top on the bottle closure but in the outer region of the seal 33, with the switch being actuated by the bottle being screwed shut tight, and the LED being switched on for a predetermined period of time. It is also possible for the LED to flash in a predetermined manner or to be switched on and off with a determined frequency pattern. A further possible embodiment consists in a rotary switch which is triggered by the closure being unscrewed or screwed up. Said rotary switch can also be designed such that the color of the LED is changed continuously while the closure is unscrewed or screwed up.

### Second Embodiment

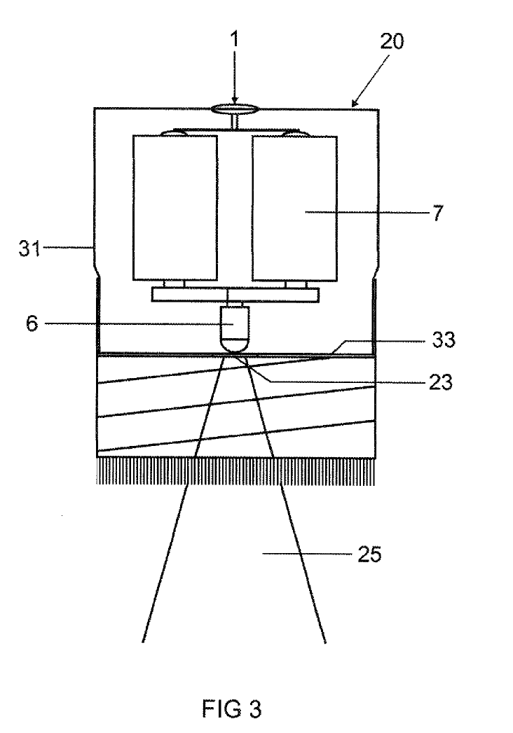

The second embodiment shown in FIG. 3 is similar to the first embodiment, and therefore only the differences from the first embodiment are described. This embodiment is likewise a screw-type closure, but the battery used is not a button cell but two bar-shaped batteries connected in series. This closure is longer as a result of the larger battery and is reusable. Provision is therefore made for the batteries to be replaced. The upper part of the closure which contains the batteries is connected to the lower screw part by a plug and socket system 31. Otherwise, the design is the same as in the first embodiment, and therefore all of the possibilities and variants of the first embodiment can also be realized here.

### Third Embodiment

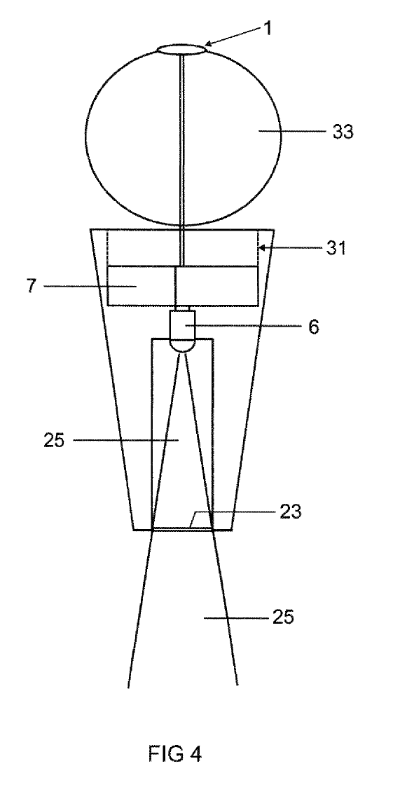

The third embodiment is similar to the second embodiment, and therefore only the differences from the second embodiment are described. The third embodiment is a closure which can be plugged onto the bottle or the hollow body, the closure being worked from a soft and flexible material such as rubber or silicone in order to be able to tightly seal the bottle. As can be seen from FIG. 4, the cone of the closure has a radially symmetrical cylindrical cutout 25 on the inside, with the LED 6 being provided at the upper end of said cutout, which LED emits its light through the cutout 25 downwards with a focused light beam 25 into the bottle. In order to protect the LED 6, in turn a window 23 is provided at the lower end of the cutout 25, and this window seals off the space of the cutout 25 hermetically from the interior of the bottle.

In this variant it would also be conceivable to provide the pushbutton switch 1 for the switch-on and switch-off operations in the cone of the closure. The pressure which is produced when the closure is plugged onto the bottle can then activate the switch.

A plug-and-socket system is also provided for this variant, and this system makes it possible to replace the battery. Owing to the design, the embodiment shown in FIG. 4 with a button cell is also of advantage here. The pushbutton switch 1 can be actuated by a top part 33 positioned on the cone, which top part 33 can at the same time also act as a grip for the replacement of the battery. The top part 33 can be a sphere, a cylinder or the like. The pushbutton switch 1 can also be incorporated in the top part 33, however, as is illustrated in FIG. 4, with the result that the top part is fixedly connected to the battery receptacle.

### Fourth Embodiment

The fourth embodiment is illustrated in FIG. 5. This embodiment is in the form of a crown cork, which has a flat shoulder which illuminates the bottle through an aperture in the crown cork. In this case, the seal consists of a transparent material, with the result that the LED and the shoulder is sealed off from the bottle contents. Owing to the very flat shape of the crown cork, a very flat button cell is used in this case. The LED is switched on and off by a flat and thin switch. Preferably, in this case a membrane switch is used. The button cell does not need to have a high capacity since the entire arrangement is designed as a disposable product. A very flat LED which is preferably provided directly on the battery base is preferably used for the LED.

### Fifth Embodiment

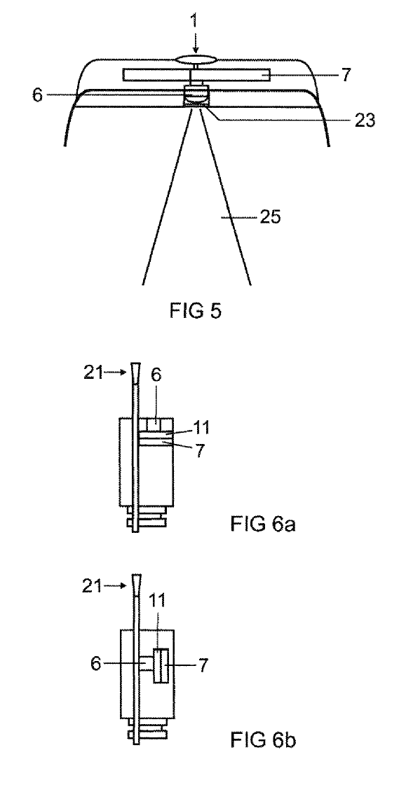

The fifth embodiment is in the form of a bottle pouring spout. Bottle pouring spouts are often used where there is little light, such as in bars and discotheques, for example. The barkeeper often has difficulties in finding the correct bottles in the dark environment and has difficulties when metering out the bottle content since the jet of liquid emerging is not easily visible. In this context, an illuminated bottle pouring spout can make this considerably easier. Since everything generally has to go quite quickly in a bar, an automatic position switch is proposed for switching the LEDs on and off. If the bottle is in the upright position, the LED is switched off, and when the bottle is tilted through at least 90°, the LED is switched on. FIG. 6a shows a first variant of the bottle pouring spout according to the invention. The LED 6 illuminates in the direction of the pouring spout in order to illuminate the jet of liquid emerging. A position-dependent switch 11 is arranged between the battery 7 and the LED 6, and this switch 11 is switched off when the bottle is in the upright position and is switched on beyond an approximately horizontal position of the bottle.

A further design is shown in FIG. 6b, in which the light is injected directly into the liquid and, so to speak, emerges from the bottle as illuminating liquid.

In order to be able to locate the bottle more easily in the dark, the position-dependent switch can also be in the form of a changeover switch. When the bottle is in the upright position, an LED directed into the bottle is switched on, and this LED illuminates the bottle and its contents. During use, this is changed over to the pouring light. By virtue of colored RGB or RGGB LEDs with color selection, the correct bottle can be identified immediately using its illuminated color.

1. An illuminated bottle closure with a dispenser function for a hollow body, the illuminated bottle closure comprising:
at least one light source, wherein the at least one light source configured to be switched on for a predetermined time when the dispenser is actuated and illuminates at least one of the liquid dispensed and the liquid contained in the dispenser.

2. The illuminated bottle closure as claimed in claim 1, wherein the illuminated bottle closure is configured such that the dispensed liquid is sprayed and the at least one light source illuminates the spray.

3. The illuminated bottle closure as claimed in claim 1, wherein the illuminated bottle closure is configured such that the dispensed liquid flows out through a pouring spout, and the at least one light source illuminates the outflowing liquid.

4. The illuminated bottle closure as claimed in claim 1, wherein the bottle closure contains an energy generator, which is configured to convert the mechanical energy produced when the dispenser button is actuated into electrical energy for operating the at least one light source.

5. The illuminated bottle closure as claimed in claim 1, wherein the dispenser contains a battery or a rechargeable battery as energy source.

6. The illuminated bottle closure as claimed in claim 3, wherein the dispenser furthermore comprises an electrical buffer store.

7. The illuminated bottle closure as claimed in claim 5, wherein the buffer store comprises at least one of a rechargeable battery and a double-layer capacitor.

8. The illuminated bottle closure as claimed in claim 1, wherein the dispenser furthermore comprises a driver circuit for the at least one light source.

9. The illuminated bottle closure as claimed in claim 1, wherein the illuminated bottle closure is configured such that the hue of the light emitted by the light source varies during operation.

10. The illuminated bottle closure as claimed in claim 9, wherein the illuminated bottle closure is configured such that the hue of the light emitted by the light source changes continuously.

11. The illuminated bottle closure as claimed in claim 9, wherein the illuminated bottle closure is configured such that the hue of the light emitted by the light source changes abruptly.

12. The illuminated bottle closure as claimed in claim 1, wherein the illuminated bottle closure is configured such that the change in hue takes place periodically.

13. The illuminated bottle closure as claimed in claim 1, wherein the light source is configured to emit light of a constant hue.

14. The illuminated bottle closure as claimed in claim 1, wherein the at least one light source is an LED.

15. The illuminated bottle closure as claimed in claim 1, wherein the at least one light source is an OLED.

16. A dispenser, comprising:
a bottle closure with a dispenser function for a hollow body, the bottle closure comprising:
at least one light source, wherein the at least one light source is configured to be switched on for a predetermined time when the dispenser is actuated and illuminates at least one of the liquid dispensed and the liquid contained in the dispenser.

17. An illuminated bottle closure for a hollow body, comprising:
at least one light source; and
a battery;
wherein the at least one light source is configured to be switched on for a predetermined time when a switch is actuated and illuminates the liquid contained in the hollow body.

18. (canceled)

19. A method for illuminating a bottle closure with a dispenser function for a hollow body with at least one light source (5, 6), the method comprising
converting the mechanical energy which is produced when the dispenser is actuated into electrical energy by means of an energy generator; and
emitting the electrical energy to the at least one light source for the operation thereof.

20. The method for illuminating a bottle closure as claimed in claim 13, wherein the energy emitted by the energy generator is converted by a driver circuit in order to apply it to the at least one light source.

21. The method for illuminating a bottle closure as claimed in claim 13, wherein the energy emitted by the energy generator is stored in a buffer store before it is emitted to the at least one light source at least one of directly and via the driver circuit.
